(19) United States
(12) Patent Application Publication
(10) Pub. No.: US 2003/0182174 A1
(43) Pub. Date: Sep. 25, 2003

(54) System and method for identifying technologies of interest to a business

(76) Inventors: Chris E. Kalish, Tarrytown, NY (US); Adam Terr, Stamford, CT (US); Joseph Kitamirike, Stamford, CT (US); Richard Agostino, Stamford, CT (US); William Tsoi, Stamford, CT (US); Yevgeniy Geltser, Stamford, CT (US)

Correspondence Address: MAYER, FORTKORT & WILLIAMS, PC, 251 NORTH AVENUE WEST, 2ND FLOOR, WESTFIELD, NJ, 07090, US

(21) Appl. No.: 10/038,881

(22) Filed: Dec. 31, 2001

(51) Int. Cl. G06F 17/60

(52) U.S. Cl. 705/10

(57) ABSTRACT

An apparatus and method to enable a business to evaluate technologies to determine whether it is worthwhile for that business to acquire it, and by which means. A universe of technologies is identified, and then reduced to a smaller number that have attracted a great deal of recent interest in trade journals and other pertinent media. A group of evaluators then scores each of these technologies using a selection tool to create a smaller still working pool of technologies for further study. The technologies in the working pool are then studied for their usability and appropriability to the business. These scores are plotted on a matrix, which provides a graphical summary of the best approach for that business to acquire the technology.

### FIELD OF THE INVENTION

The present invention relates to systems and methods for identifying technologies of value to a business.

### BACKGROUND OF THE INVENTION

Businesses are faced with numerous challenges in the marketplace concerning the development and deployment of new technologies. In the first instance, if a business fails to become aware of a new technology, it is at risk for finding itself at a competitive disadvantage with respect to its competitors. This is especially true of businesses that are heavily dependent on the use of new technologies for growth. Also, even where a business is aware of a technology, it must decide whether and how best to acquire it. While a business can develop a technology on its own and certainly many do, very often it is more effective to acquire new technology from elsewhere through relationships with others.

When a business learns of a technology that is of interest to it, it can seek to acquire that technology through any or all of the following actions:

It can adopt it on its own, either by buying it in the marketplace from others who have it for sale, or by making it in-house (assuming that there are no legal impediments to its doing so, such as the existence of a patent).

It can partner with a vendor of that technology.

It can directly invest in a company that has the technology of interest.

These approaches involve differing degrees of “intimacy” in the corporate interactions required. For example, the decision to invest capital in another business requires far more due-diligence work and entail far more exposure to corporate risk than merely buying a technology off the shelf from a vendor.

Given the large sums of money involved in many of these kinds of transactions, the decision making process itself bears further scrutiny. To-date, this decision-making process has generally been a somewhat informal, highly subjective affair, in which managers look at whatever technologies they happen to be aware of and apply a varying set of methodologies to study them. While this approach may work in some cases, it has a number of serious drawbacks. First, the process by which a decision is made is often opaque to outsiders, such as investors, boards of directors, and regulators, and not readily reproducible. Second, the individuals tasked with identifying new technologies of interest may not have the time or inclination or ability to keep fully abreast with the universe of new technologies in which a business might well be interested. There is, therefore, a degree of randomness and unpredictability in the process.

### SUMMARY OF THE INVENTION

The present invention provides a systematic approach to the problem of identifying technologies (or, more broadly speaking, other business opportunities) of potential interest to the management of a business or company, by employing both compute r-driven and human methodologies in a manner that utilizes the native strengths of each. The approach proceeds along four primary steps:

1.IDENTIFICATION: A potential universe of all technologies is identified, and from them a select group of technologies that have attracted particular interest in various relevant media is culled out using an objective tool such as a computer executing a program.

2. SELECTION/ELIMINATION: a small group of people (e.g. ten) rank each of these technologies via a scoring tool. While the scores are provided by individuals and thus reflect their individual biases, in the aggregate, subjected to statistical analysis via a computer algorithm, they provide a more objective measure of the merits of the technology (or other business opportunity) under study, as individual biases become subsumed in the group. A high scoring group of technologies thus identified forms a “working pool” for further study.

3. EVALUATION: Each of the technologies in the working pool is forwarded to an evaluator, an individual especially familiar with that technology, who considers that technology in depth from the standpoint of certain additional factors. These are:

A) usability: a compound measure of functionality, portability, and performance/aesthetic features; and

B) appropriability: a compound measure of vendor and product positioning in the marketplace.

Scores corresponding to each of these two characteristics are calculated from the evaluator's numerical evaluations of the technology as prompted by a series of criteria appropriate for that technology. These criteria are set forth in two tools, a usability tool and an appropriability tool, which calculate the overall scores for each. The resulting final scores are then plotted on a graph such as a matrix, which provides a simple visual summary of the process and a recommendation as to how the business should approach it (i.e., ignore, adopt, partner or invest).

4. ACTION: A report (including the matrix plots) of those technologies having suitably high usability/appropriability scores is conveyed to management for action, and the process transitions from one of analysis to decision by management.

### DESCRIPTION OF THE DRAWINGS

FIG. 1 is a block diagram of an embodiment of this invention, and illustrates the overall sequence of steps.

FIG. 2 is a flow chart of the invention, shown for a particular embodiment.

FIG. 3 provides an overview of the process of identifying technologies of initial interest.

FIG. 4 illustrates the selection elimination process using a selection elimination tool.

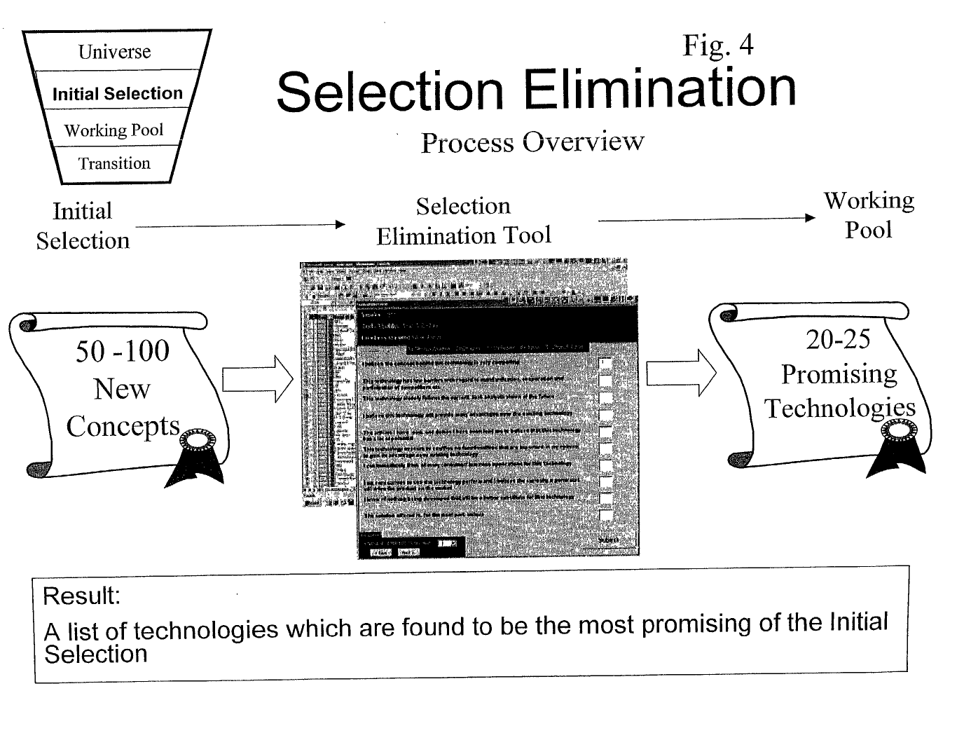

FIG. 5 illustrates the testing and evaluation stage, in which the number of technologies is further culled.

FIG. 6 is the decision matrix that results from the process.

### DETAILED DESCRIPTION

The invention will be described in terms of an illustrative specific embodiment, shown in the Figures.

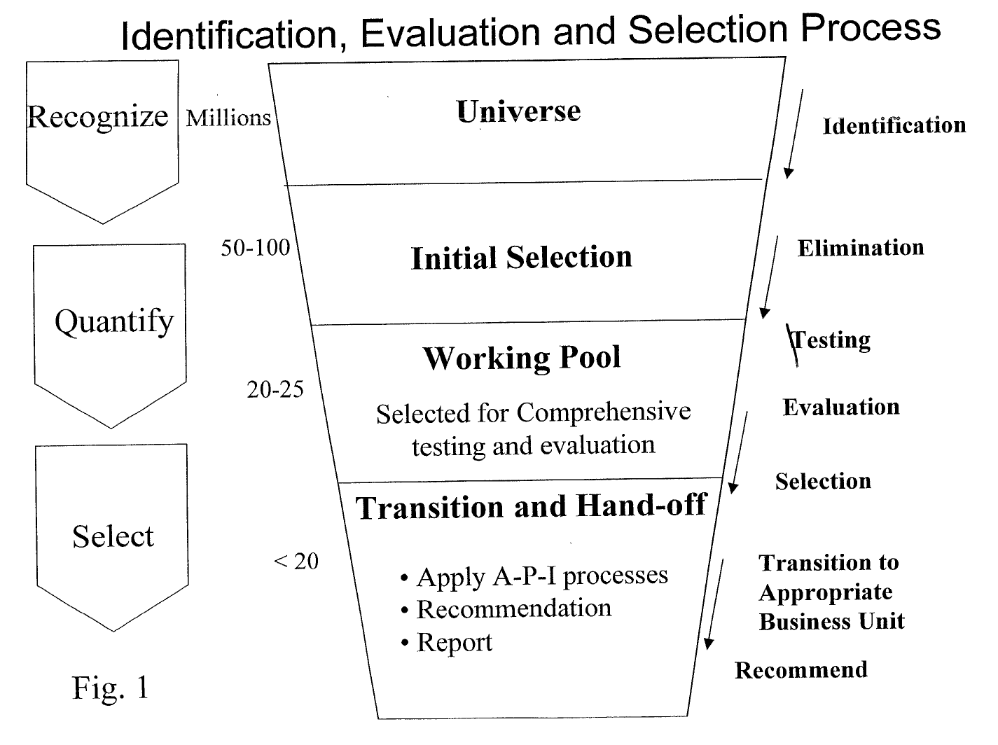

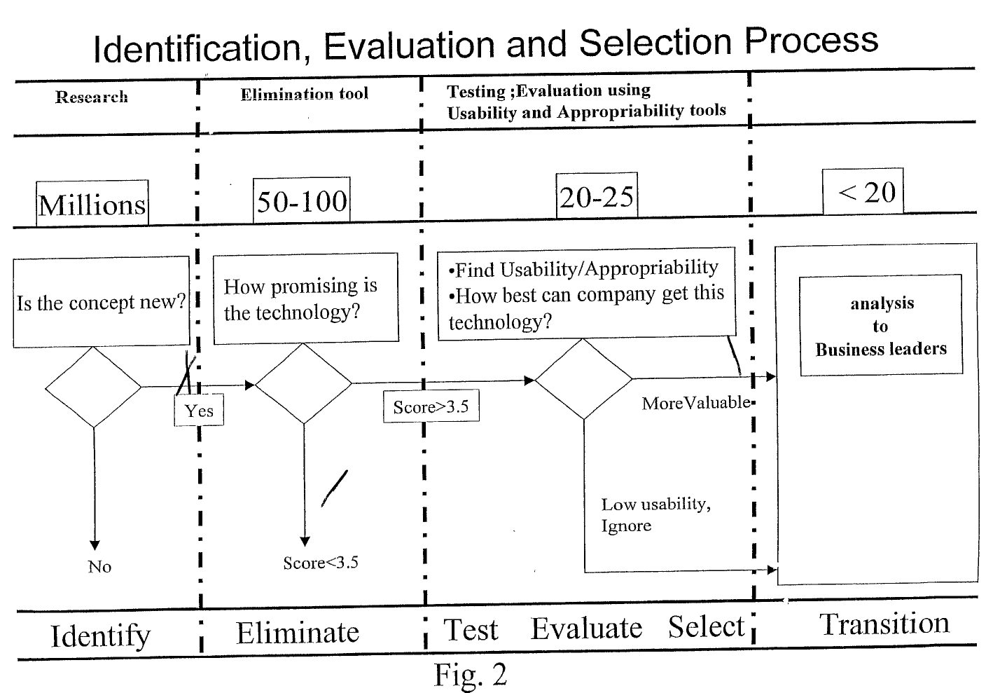

FIGS. 1 and 2 show the overall sequence of the invention, from identifying a manageable group of technologies for study from among the universe of millions of potential technologies, to the use of an elimination tool to reduce the number further, to testing and evaluation, to the generation of a report.

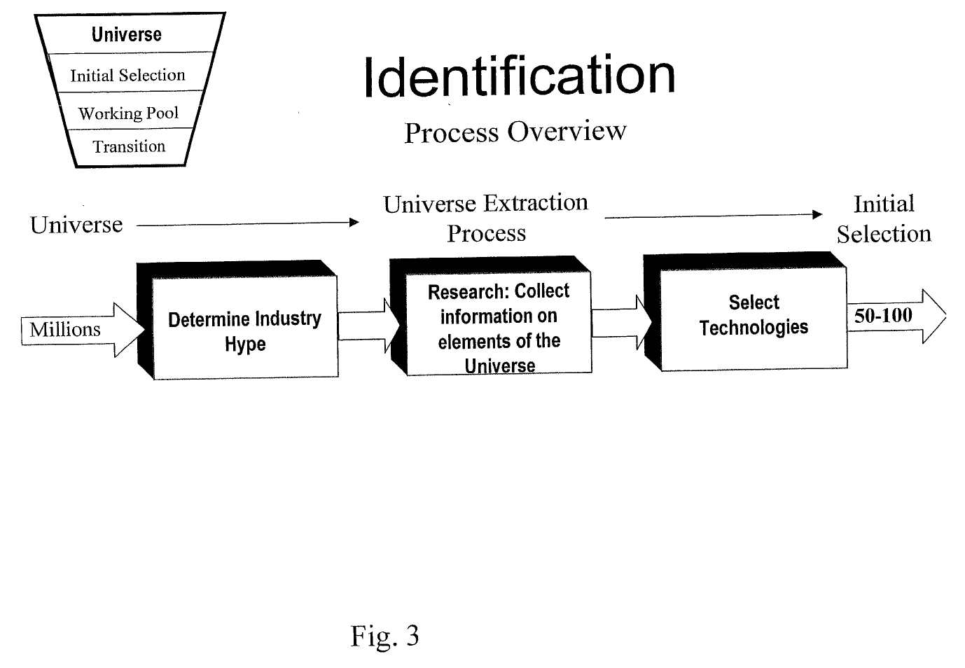

The first step (FIG. 3) is to identify a universe of emerging technologies of theoretical interest. There are many possible definitions of what constitutes a technology of at least theoretical “interest” to a business, and this will depend somewhat on the needs and interests of the business in question. From this universe a set of approximately 50-100 technologies is culled. (The numbers recited in this example likely will vary in practice with the resources at hand.) In this example, the immediate focus is on technologies that have attracted a certain level of interest in some pertinent part of the press or public's eye. A list of such possibilities can be generated by first identifying a pertinent set or resources to examine. These include:

company research and development documents;

academic research;

technology oriented journals;

trade shows;

press releases;

information gleaned from vendors; and

personal contacts within and external to the business.

The next step in the process is to search these sources for technologies that appear to have attracted a suitable degree of interest or “hype.” There are a number of ways of doing this, including performing a manual scan of the literature, but in this embodiment it is preferred that computers be used to accomplish this electronically, for example by counting the number of times a technology is mentioned in the relevant journals or cited in publications, including on web pages. (There are commercially available tools to accomplish this, including any that scour web pages accessible on the internet to count the number of times that a technology is mentioned, which is a reasonable first-order measure of interest or “hype” associated with that technology. One tool suitable for this purpose has been developed by Themescape, Incorporated.) One consideration is that the technology be new. Other considerations are that the technology have specific features that are not yet widely in use, that it be in the hands of a small number of individuals or organizations, and that the technology be experiencing its first burst of publicity. (This can be determined by examining the dates of the citing articles, and paying particular heed to those technologies for which many recent citations have been found in combination with a paucity of citations for that technology prior to a predetermined date.) By whichever tool is employed for this process of identification, some manageable subset, such as the fifty to one hundred of the most promising technologies that are currently the subject of great interest in industry are identified. This set of technologies defines the “initial selection” and is marked for further study.

After this first set of 50-100 technologies has been identified, each undergoes evaluation by a team of human evaluators who manually rate each of these technologies. In this embodiment, a group of ten human evaluators is used. These evaluators are provided with a scored elimination tool, which is used to further reduce the number of technologies under consideration to approximately 25. The elimination tool is built around a questionnaire that presents a set of weighted criteria (e.g., ten) against which each of the technologies is scored by each of the evaluators on a scale that varies from 1 (low) to 5 (high). The weights given to each question can be varied, as can the number and type of questions, depending on the needs of the end user. One example of one possible set of criteria is shown in table one and is further explained in table two below:

TABLE 1
Criteria Used in Elimination Tool

| Weight | |
|---|---|
| 5% | The solution offered is, for the most part, unique |
| 20% | This technology has low barriers with regard to standardization, |
| | cooperation and participation of competitors etc. |
| 5% | This technology closely follows the current tech analysts vision |
| | of the future |
| 5% | I believe this technology will provide many advantages over the |
| | existing technology |
| 5% | The articles I have read, and demos I have seen lead me to |
| | believe that this technology has a lot of potential |
| 15% | This technology appears to sacrifice no functionalities that are |
| | important in my opinion to gain its advantage over existing |
| | technolog |
| 5% | I can immediately think of many consumer/business applications |
| | for this technology |
| 5% | I am very curious to see the technology perform and I believe |
| | the curiosity it generates will drive the product on the market |
| 5% | I know of nothing being developed that will be a better substitute |
| | for this technology |
| 30% | I believe the concept behind this technology is very compelling |
| 100% | Total Score |

TABLE 2
Description of Elimination Criteria

| | |
|---|---|
| 1 | The solution offered is, for the most part, unique |
| | There are no other technologies that offer the same solution |
| | Technologies can be adapted to fit the solution, however this |
| | technology is designed as a unique solution |
| | There exists many technologies that offer similar solutions |
| 2 | This technology has low barriers with regard to standardization, |
| | cooperation and participation of competitors etc. |
| | Standards are already in place to facilitate wide adoption |
| | Standards needed are on the horizon |
| | This technology requires a set of new standards |
| 3 | This technology closely follows the current tech analysts vision |
| | of the future |
| | The technology is an important part of many roadmaps |
| | There is ambivalence surrounding the vision of this technology |
| | Technology analysts and current visions do not include this |
| | technology |
| 4 | I believe this technology will provide many advantages over the |
| | existing technology |
| | The new technology will provide a more efficient solution than any |
| | existing technologies |
| | There are advantages and disadvantages to using the new technology |
| | The existing technology provides a more efficient solution |
| 5 | The articles I have read, and demos I have seen lead me to believe |
| | that this technology has a lot of potential |
| | From the information I have gathered, I believe in the technology's |
| | future |
| | From the information I have gathered, I am undecided as to my belief |
| | in the technology's future |
| | From the information I have gathered, I do not believe in the |
| | technology's future |
| 6 | This technology appears to sacrifice no functionalities that are |
| | important in my opinion to gain its advantage over existing |
| | technology |
| | The new technology offers more functionality and features than |
| | existing technology |
| | There is no significant difference in the features and functionality |
| | between new and existing technologies |
| | Existing technology has more functionality, features |
| 7 | I can immediately think of many consumer/business applications for |
| | this technology |
| | I can envision many diverse market applications for this technology |
| | There is a limited number of markets for this product |
| | I do not see any potential markets for this technology |
| 8 | I am very curious to see the technology perform and I believe the |
| | curiosity it generates will drive the product on the market |
| | The product has novel functionalities, and/or features that will be |
| | valued by the market |
| | The product has novel features, however they will not be valued by |
| | the market |
| | The product has no novel functionalities, and/or features that would |
| | be valued by the market |
| 9 | I know of nothing being developed that will be a better substitute for |
| | this technology |
| | When the technology enters the market it will be superior to |
| | substitutes entering the market in the same time frame |
| | Nothing distinguishes this product from other substitutes that will |
| | be entering the market |
| | There are already products on the market that are better substitutes |
| | for this technology |
| 10 | I believe the concept behind this technology is very compelling |
| | This concept will be a “killer app”/It is a revolutionary concept |
| | with high potential to penetrate the market (i.e. Internet, E-mail, GUI) |
| | This is a good concept, however it will be easily substituted by new |
| | technologies in the near future |
| | This concept has no potential to make an impact on the market/It is |
| | very similar to existing technology |

The criteria may be presented to an evaluator online, or they may be provided on paper in a form such as is presented below in Table 3:

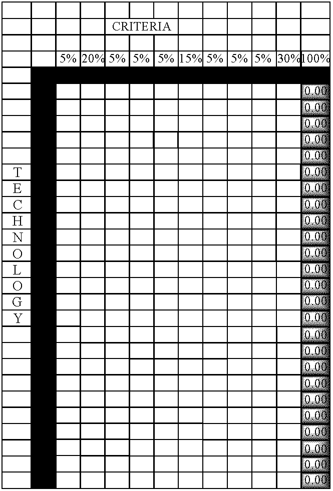

These scores provided by each evaluator are then summarized on a spread sheet. For example, the following spread sheet format shows what a filled in form from an individual evaluator after his review of the fifty technologies set forth in the initial selection:

TABLE 4

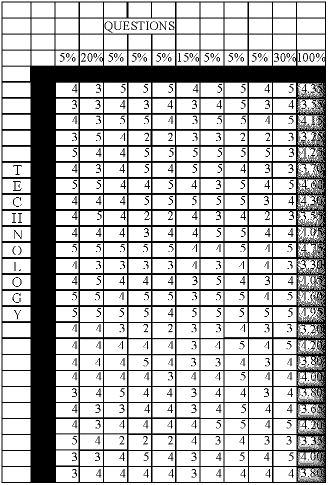

The next step in the process is the statistical analysis of the evaluation data provided by the evaluators. A standard statistical package can be used with a spread sheet program to consider the evaluations of all of the evaluators for each of the technologies evaluated, and readily provide such fundamental measures of each criteria as mean score, standard deviation, minimum and maximum score or any other statistical measure that may be of interest. In this example, an overall score of less than 3.5 indicates that the technology is not of interest; a score greater than 3.5 indicates that the technology should be subjected to further scrutiny. Table 5 presents one form that a table summarizing this data (here analyzing the overall scores of 50 technologies as developed by a team of ten evaluators) can take:

TABLE 5
STATISTICAL ANALYSIS

| # | Mean | St. Dev. | Min | Max |
|---|---|---|---|---|
| 1 | 4.35 | (based | 4.35 | 4.35 |
| 2 | 3.55 | On | 3.55 | 3.55 |
| 3 | 4.15 | Data | 4.15 | 4.15 |
| 4 | 3.25 | For | 3.25 | 3.25 |
| 5 | 4.75 | Each) | 4.75 | 4.75 |
| 6 | 3.70 | | 3.7 | 3.7 |
| 7 | 4.60 | | 4.6 | 4.6 |
| 8 | 4.30 | | 4.3 | 4.3 |
| 9 | 3.55 | | 3.55 | 3.55 |
| 10 | 4.05 | | 4.05 | 4.05 |
| 11 | 4.75 | | 4.75 | 4.75 |
| 12 | 3.30 | | 3.3 | 3.3 |
| 13 | 4.05 | | 4.05 | 4.05 |
| 14 | 4.60 | | 4.6 | 4.6 |
| 15 | 4.95 | | 4.95 | 4.95 |
| 16 | 3.20 | | 3.2 | 3.2 |
| 17 | 4.20 | | 4.2 | 4.2 |
| 18 | 3.80 | | 3.8 | 3.8 |
| 19 | 4.00 | | 4 | 4 |
| 20 | 3.80 | | 3.8 | 3.8 |
| 21 | 3.65 | | 3.65 | 3.65 |
| 22 | 4.20 | | 4.2 | 4.2 |
| 23 | 3.35 | | 3.35 | 3.35 |
| 24 | 4.00 | | 4 | 4 |
| 25 | 3.80 | | 3.8 | 3.8 |
| 26 | 2.95 | | 2.95 | 2.95 |
| 27 | 3.90 | | 3.9 | 3.9 |
| 28 | 4.70 | | 4.7 | 4.7 |
| 29 | 3.85 | | 3.85 | 3.85 |
| 30 | 3.55 | | 3.55 | 3.55 |
| 31 | 4.10 | | 4.1 | 4.1 |
| 32 | 3.80 | | 3.8 | 3.8 |
| 33 | 3.90 | | 3.9 | 3.9 |
| 34 | 4.50 | | 4.5 | 4.5 |
| 35 | 3.90 | | 3.9 | 3.9 |
| 36 | 3.00 | | 3 | 3 |
| 37 | 3.00 | | 3 | 3 |
| 38 | 3.00 | | 3 | 3 |
| 39 | 3.85 | | 3.85 | 3.85 |
| 40 | 4.00 | | 4 | 4 |
| 41 | 3.95 | | 3.95 | 3.95 |
| 42 | 4.35 | | 4.35 | 4.35 |
| 43 | 3.80 | | 3.8 | 3.8 |
| 44 | 3.90 | | 3.9 | 3.9 |
| 45 | 3.80 | | 3.8 | 3.8 |
| 46 | 4.35 | | 4.35 | 4.35 |
| 47 | 3.75 | | 3.75 | 3.75 |
| 48 | 3.70 | | 3.7 | 3.7 |
| 49 | 2.60 | | 2.6 | 2.6 |
| 50 | 3.85 | | 3.85 | 3.85 |

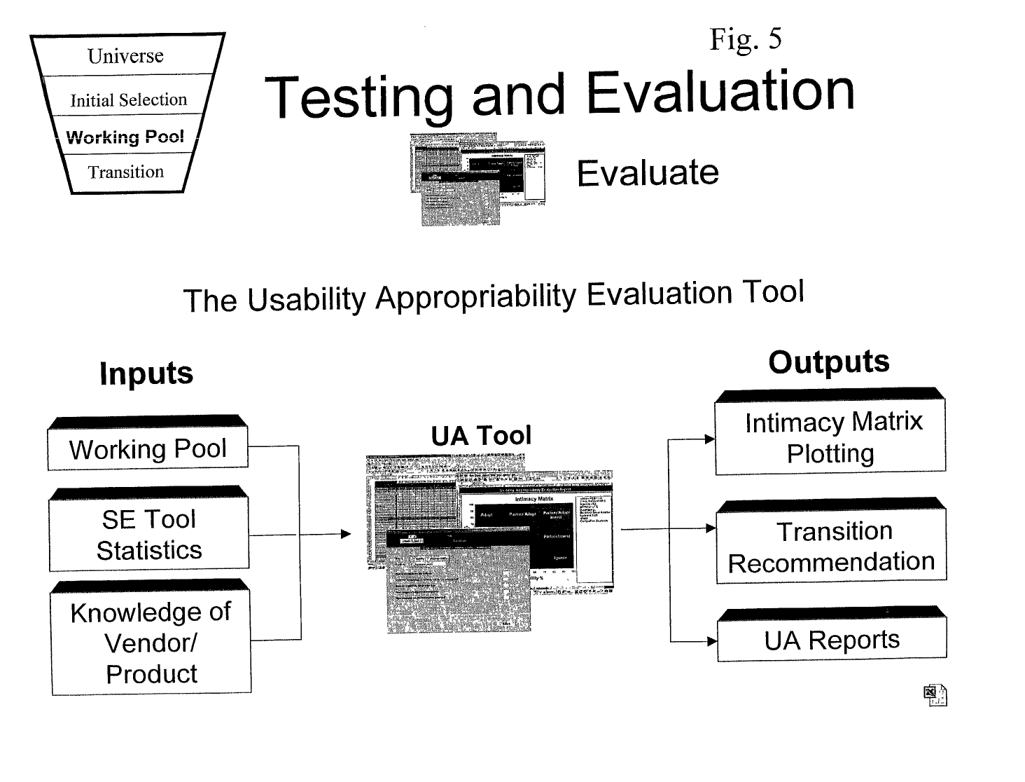

These scores are then ranked from high to low, and the highest scoring technologies (in this example, the top 25) are selected to form a working pool for comprehensive testing and evaluation (FIG. 5).

At the testing and evaluation stage, each of the technologies of the working pool is assigned to a single evaluator for further study. Physical “hands-on” tests are made of that technology to determine measures of both its “usability” and “appropriability”. “Usability” is defined here to be a compound measure of product performance characteristics, user friendliness, aesthetic qualifies and readiness for market. “Appropriability” is defined in terms of vendor and product positioning in the marketplace and the like, and also reflects the desire of the target company to gain equity funding In each case, the Evaluator is provided with a form or questionnaire that presents a set of weighted criteria against which each of the technologies is scored by the Evaluator, again on a scale that varies from 1 (low) to 5 (high). The weights given to each question can be varied, as can the number and type of questions, depending on the needs of the end user. The set of criteria used to judge usability is known here as the usability tool, and the set of criteria used to judge appropriability is referred to here as the appropriability tool. A high usability score indicates that a technology is ready for commercial deployment; a high appropriability score indicates favorable vendor and product positioning with respect to the technology.

One example of possible sets of criteria for the usability and appropriability tools is set forth in tables 6 and 7 below:

TABLE 6
USABILITY CRITERIA

| | | RANK | MAX |
|---|---|---|---|
| FUNCTIONALITY | WEIGHT | (1-5) | SCO |
| User Friendliness | | | |
| The controls are accessible | 3 | 5 | 0.00 |
| The technology completely satisfies the | 3 | 5 | 0.00 |
| primary task | | | |
| It completely resolves the task | 2 | 5 | 0.00 |
| The set of instructions is very simple to use | 1 | 5 | 0.00 |
| The instructions provided are accurate | 3 | 5 | 0.00 |
| | 12 | 25 | 0.00 |
| Efficiency | | | |
| The machine/software starts up fast | 1 | 5 | 0.00 |
| The machine/software responds fast to the | 3 | 5 | 0.00 |
| task | | | |
| The different modules/parts communicate | 3 | 5 | 0.00 |
| easily | | | |
| The product gives an accurate response | 2 | 5 | 0.00 |
| | 9 | 20 | 0.00 |
| APPLICABILITY | | | |
| The product is suitable for the target | 3 | 5 | 0.00 |
| applications | | | |
| The technology provides a unique solution | 2 | 5 | 0.00 |
| The technology has potential to increase | 3 | 5 | 0.00 |
| productivity | | | |
| The technology has potential to reduce cost | 3 | 5 | 0.00 |
| The technology entails a low cost of | 2 | 5 | 0.00 |
| implementation | | | |
| | 13 | 25 | 0.00 |
| PORTABILITY | | | |
| The product is not bulky | 3 | 5 | 0.00 |
| The technology is adaptable to different | 3 | 5 | 0.00 |
| network environments | | | |
| The technology consumes low amounts of | 2 | 5 | 0.00 |
| power | | | |
| The technology is portable across several | 2 | 5 | 0.00 |
| platforms | | | |
| | 10 | 20 | 0.00 |
| AESTHETIC FEATURES | | | |
| The product looks appealing | 3 | 5 | 0.00 |
| It is physically comfortable to work with | 3 | 5 | 0.00 |
| The controls are well located | 2 | 5 | 0.00 |
| The key parts are arranged conveniently | 2 | 5 | 0.00 |
| The controls are sized appropriately | 1 | 5 | 0.00 |
| The product's color scheme is appropriate | 1 | 5 | 0.00 |
| for the targeted market(s) | | | |
| | 12 | 30 | 0.00 |

Total Score

TABLE 6
APPROPRIABILITY

| | IMPOR- | RANK | MAX |
|---|---|---|---|
| FUTURE POTENTIAL | TANCE | (1-5) | SCORE |
| The product imitates existing technologies | 2 | 5 | 0.0 |
| The product substitutes existing | 1 | 5 | 0.0 |
| technologies | | | |
| The product is ready for the market | 2 | 5 | 0.0 |
| The product offers potential for the | 2 | 5 | 0.0 |
| technology to evolve to other uses | | | |
| There are no other products in the pipeline | 1 | 5 | 0.0 |
| that would threaten this technology | | | |
| The product will attract a large initial | 3 | 5 | 0.0 |
| market | | | |
| The market for this product will grow with | 3 | 5 | 0.0 |
| time | | | |
| | 14 | 35 | 0.0 |
| VENDOR | | | |
| The vendor cannot achieve scale | 3 | 5 | |
| The technology has extensive proprietary | 2 | 5 | |
| differentiation | | | |
| The technology entails a low switching | 1 | 5 | |
| cost | | | |
| The vendor's brand is not easily | 2 | 5 | |
| recognizable | | | |
| The company does not have the resources | 3 | 5 | |
| to fund development and marketing of the | | | |
| technology | | | |
| The vendor does not have established | 3 | 5 | |
| distribution networks | | | |
| The company cannot contain retaliatory | 2 | 5 | |
| action from established players | | | |
| | 16 | 35 | |
| COMPETITION | | | |
| The competition is diverse | 2 | 5 | |
| The competitors' brands are as | 2 | 5 | |
| recognizable as the vendor's | | | |
| The competition cannot easily imitate the | 3 | 5 | |
| vendor's ideas | | | |
| The competition has a high level of | 3 | 5 | |
| specialized assets, distribution networks | | | |
| and a large customer base | | | |
| Switching from a competitor's product | 1 | 5 | |
| entails a low switching cost | | | |
| Competitors do not have the resources to | 2 | 5 | |
| retaliate or imitate | | | |
| | 13 | 30 | |
| CUSTOMERS | | | |
| The customer does not have a range of | 3 | 5 | |
| substitutes available in the market | | | |
| Customers have a high propensity to | 3 | 5 | |
| substitute products | | | |
| Buyers have limited bargaining power | 2 | 5 | |
| The technology attractive to decision | 1 | 5 | |
| makers | | | |
| Buyers are not very sensitive to price | 1 | 5 | |
| Customers recognize the vendor's brand | 3 | 5 | |
| easily | | | |
| Buyers are interested and capable of | 1 | 5 | |
| backward integration (acquire the vendor) | | | |
| The technology significantly impacts | 2 | 5 | |
| quality and performance of the buyer | | | |
| | 18 | 40 | |
| SUPPLIERS | | | |
| Suppliers have limited bargaining power | 2 | 5 | |
| There are substitute inputs | 1 | 5 | |
| The inputs do not have a significant | 3 | 5 | |
| impact on cost and product differentiation | | | |
| Suppliers are interested and capable of | 3 | 5 | |
| forward integration (acquire the vendor) | | | |
| | 131 | | |

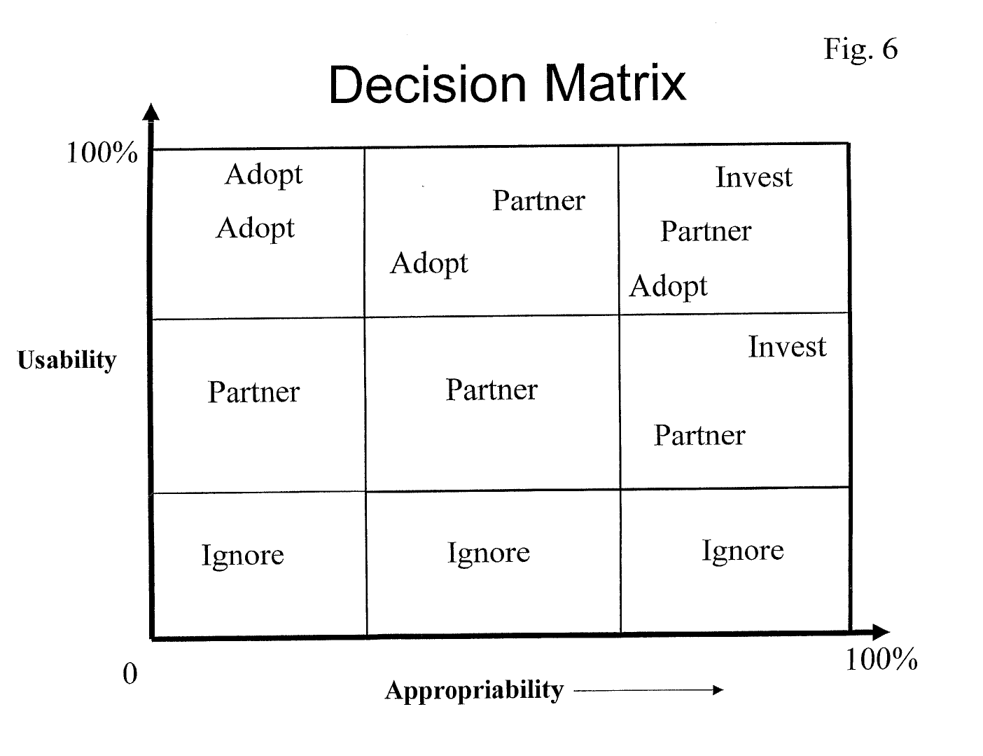

Preferably, a computer is then used to tally up the weighted usability and appropriability scores of each technology studied, normalized to a percentile score, with 100 being the maximum possible score. (Each of these tools can be implemented in a variety of ways, including on a spreadsheet or other commercially available software package having the ability to analyze data by providing weighted sums and basic statistical measures.) These numbers are then used as the coordinates to plot the position of the technology on a Decision Matrix (FIG. 6) having axial dimensions of usability and appropriability. The matrix is marked off into a three by three rectangular form of nine labeled spaces, as shown in FIG. 6. Depending upon which part of the matrix a technology falls, a recommendation is made to managers on whether to ignore the technology, adopt it, partner with a vendor or invest in the company to acquire an equity position in it. Generally speaking, the corner that is closest to the origin identifies the least valuable technologies (i.e., low usability and low appropriability). The upper right hand corner indicates the most valuable technologies, which are recommended for adoption, partnering or investment. The other areas of the matrix identify less favorable assessments where nevertheless the technology has some merit worth pursuing. Alternatively, another medium for presenting this data in readily discernable visual form can be employed, such as other kinds of charts, graphs, tabulations, etc.

This approach thus provides management with a tool for evaluating technologies that takes advantage of the strengths of both human judgement in evaluating a technology and the computational power of machines to provide a graphical overview of the merits of acquiring a technology. It is to be understood that the specific criteria presented here can be supplemented by other criteria. For example, one of the areas that an evaluator may be chosen to review is the degree to which the technology in question is covered by a patent, which can influence the decision whether to adopt, partner, or invest for that technology. Also, the criteria can be modified to reflect the specific needs of a business.

What is claimed is:

1. A method for evaluating the merits of a plurality of business opportunities, comprising the steps of:
identifying a first set of potential business opportunities of interest to a business from an initial, larger pool of business opportunities;
analyzing the first set of business opportunities by having a group of persons evaluate them using an elimination tool which generates a set of data, said data providing for a ranking of said business opportunities in the first set;
culling from the first set of business opportunities a reduced second set of business opportunities having sufficiently high ranking;
analyzing the second set of business opportunities to determine a numerical first characteristic and a numerical second characteristic for each of them; and
providing a graphical representation of the first and second characteristics for at least some of the business opportunities in the second set.

2. A method as set forth in claim 1, wherein the initial, larger pool of business opportunities is identified by examining publications of interest.

3. A method as set forth in claim 1, wherein the first set of potential business opportunities is characterized by a disproportionate amount of recent publicity.

4. A method as set forth in claim 3, wherein the first set of potential business opportunities is characterized by little publicity prior to a selected date.

5. A method as set forth in claim 1, wherein web pages are searched for business opportunities.

6. A method as set forth in claim 1, wherein the elimination tool comprises a set of criteria for judging the first set of business opportunities.

7. A method as set forth in claim 6, wherein the criteria include an evaluation of the uniqueness of the opportunity.

8. A method as set forth in claim 6, wherein the criteria include an evaluation of the advantages of the business opportunity over other business opportunities.

9. A method as set forth in claim 1, wherein each of the business opportunities is evaluated by each of the persons.

10. A method as set forth in claim 6, wherein each person provides a score for each of the criteria for every business that the persona evaluates.

11. A method as set forth in claim 1, wherein the elimination tool provides a statistical summary of the numerical rankings.

12. A method as set forth in claim 1, wherein a computer is used to collect and analyze the data generated by use of the elimination tool.

13. A method as set forth in claim 1, wherein a computer is used to determine the first and second characteristics.

14. A method as set forth in claim 1, wherein the first numerical characteristic is a measure of the usability of the business opportunity.

15. A method as set forth in claim 1, wherein the second numerical characteristic is a measure of the ease with which the opportunity can be acquired.

16. A method as set forth in claim 1, wherein the numerical first and second characteristics are determined by evaluating a business opportunity according to first and second sets of criteria.

17. A method as set forth in claim 16, wherein a single person determines numerical rankings for the criteria.

18. A method as set forth in claim 1, wherein the numerical values of the first and second characteristics determine whether the business opportunity is one that should be pursued by an approach selected from the group consisting of adoption, partnering, and investing.

19. A method as set forth in claim 1, wherein the numerical values of the first and second characteristics are plotted on a graph.

20. A method as set forth in claim 19, wherein the graph is in the form of a matrix.

21. A method as set forth in claim 20, wherein the matrix is divided into nine rectangles which are labeled by at least one of the words adopt, partner, invest, and ignore.

22. A method for evaluating the merits of a plurality of technologies for acquisition by a business, comprising the steps of:
identifying a first set of potential technologies of interest to a business from an initial, larger pool of technologies;
analyzing the first set of technologies by having a group of persons evaluate them using an elimination tool which generates a set of data, said data providing for a ranking of said technologies in the first set;
culling from the first set of technologies a reduced second set of technologies having sufficiently high ranking;
analyzing the second set of technologies to determine a numerical first characteristic and a numerical second characteristic for each of them,
providing a graphical representation of the first and second characteristics for at least some of the technologies in the second set.

23. A method as set forth in claim 22, wherein the initial, larger pool of technologies is identified by examining publications of interest.

24. A method as set forth in claim 22, wherein the first set of potential technologies is characterized by a disproportionate amount of recent publicity.

25. A method as set forth in claim 24, wherein the first set of potential technologies is characterized by little publicity prior to a selected date.

26. A method as set forth in claim 22, wherein web pages are searched for technologies.

27. A method as set forth in claim 22, wherein the elimination tool comprises a set of criteria for judging the first set of technologies.

28. A method as set forth in claim 27, wherein the criteria include an evaluation of the uniqueness of the technology.

29. A method as set forth in claim 27, wherein the criteria include an evaluation of the advantages of the technology over other technologies.

30. A method as set forth in claim 22, wherein each of the business opportunities is evaluated by each of the persons.

31. A method as set forth in claim 27, wherein each person provides a score for each of the criteria for every business that the persona evaluates.

32. A method as set forth in claim 22, wherein the elimination tool provides a statistical summary of the numerical rankings.

33. A method as set forth in claim 22, wherein a computer is used to collect and analyze the data generated by use of the elimination tool.

34. A method as set forth in claim 22, wherein a computer is used to determine the first and second characteristics.

35. A method as set forth in claim 22, wherein the first numerical characteristic is a measure of the usability of the technology.

36. A method as set forth in claim 22, wherein the second numerical characteristic is a measure of the ease with which the technology can be acquired.

37. A method as set forth in claim 22, wherein the numerical first and second characteristics are determined by evaluating a technology according to first and second sets of criteria.

38. A method as set forth in claim 37, wherein a single person determines numerical rankings for the criteria.

39. A method as set forth in claim 22, wherein the numerical values of the first and second characteristics determine whether the business opportunity is one that should be pursued by an approach selected from the group consisting of adoption, partnering, and investing.

40. A method as set forth in claim 22, wherein the numerical values of the first and second characteristics are plotted on a graph.

41. A method as set forth in claim 40, wherein the graph is in the form of a matrix.

42. A method as set forth in claim 41, wherein the matrix is divided into nine rectangles which are labeled by at least one of the words adopt, partner, invest, and ignore.

43. An apparatus for evaluating the merits of a plurality of technologies for acquisition by a business, comprising:
means for identifying a first set of potential technologies of interest to a business from an initial, larger pool of technologies;
means for analyzing the first set of technologies by having a group of persons evaluate them using an elimination tool which generates a set of data, said data providing for a ranking of said technologies in the first set;
means for culling from the first set of technologies a reduced second set of technologies having sufficiently high ranking;
means for analyzing the second set of technologies to determine a numerical first characteristic and a numerical second characteristic for each of them; and
means for providing a graphical representation of the first and second characteristics for at least some of the technologies in the second set.

44. An apparatus as set forth in claim 43, wherein the means for identifying a first set of potential technologies comprises a computer.

45. An apparatus as set forth in claim 43, wherein the means for analyzing the first set of technologies comprises a set of numerically gradable criteria provided to the persons.

46. An apparatus as set forth in claim 43, wherein the means for culling from the first set of technologies a reduced second set of technologies comprises a computer.

47. An apparatus as set forth in claim 43, wherein the means for analyzing the second set of technologies comprises both human judgement and machine calculation.

48. An apparatus as set forth in claim 43, wherein the means for providing a graphical representation comprise a matrix.
